(19) United States
(12) Patent Application Publication
(10) Pub. No.: US 2024/0196254 A1
(43) Pub. Date: Jun. 13, 2024

(54) METHOD FOR DETERMINING STATIONARY CONDITION OF WIRELESS DEVICE

(71) Applicant: Sony Group Corporation, Tokyo (JP)

(72) Inventors: Basuki PRIYANTO, Lund (SE); Anders BERGGREN, Lund (SE)

(21) Appl. No.: 18/288,000

(22) PCT Filed: Apr. 12, 2022
(86) PCT No.: PCT/EP2022/059681

§ 371 Date: Oct. 23, 2023

(30) Foreign Application Priority Data
May 10, 2021 (SE) 2150594-6

(51) Int. Cl. H04W 24/10; H04W 64/00; H04W 74/0833

(52) U.S. Cl. CPC H04W 24/10; H04W 64/00; H04W 74/0833

(57) ABSTRACT

Method carried out in a user equipment, UE, (1) for evaluating a stationary condition of the UE, the method comprising: measuring (408) a signal property based on one or more signals received from the radio network: determining (410) a statistical value indicative of signal property variation based on consecutive measurements of the signal property: determining (411) that the UE is in a stationary condition responsive to the statistical value satisfying a predetermined criterion.

### TECHNICAL FIELD

This disclosure relates to methods and devices in a wireless communication system, in which device operate by wireless communication with a radio network. Specifically, solutions are provided for a wireless device to determine that it is in a stationary condition, so as to enable reduced signaling and processing.

### BACKGROUND

In radio communication systems, such as different generations provided through the 3rd Generation Partnership Project (3GPP), various specifications have been provided for setting up common rules for operating both a radio network and wireless devices, and a wireless radio interface for communication with between wireless devices and the radio network. In 3GPP documentation, a wireless device is commonly referred to as a User Equipment (UE), a term that will be used herein for the sake of simplicity. The radio network may comprise a core network and one or more radio access network (RAN) which includes one or more access nodes, operative to provide radio access to UEs within one or more cells. Such access nodes may also be referred to as base stations, and various terms are used in 3GPP for different types of systems or specifications. In the so-called 5G specifications, in which an access technology referred to as New Radio (NR) the term gNB is commonly used to denote an access node.

While cellular wireless systems were originally developed with the objective of providing voice communication, radio systems of recent generations of 3GPP specifications are mainly operated and optimized for the purpose of data communication. Such data communication may have different types and levels of requirements. For certain operations, large data throughput may be required, whereas for other services latency is a more important feature to optimize. Moreover, the evolvement of 3GPP releases has provided for less complex wireless communication and less capable UEs, where the periodicity between communication occasions with the radio network may be extended, and requirement for monitoring the radio network may be relaxed in the UE.

A UE with reduced capability is currently being introduced as part of 5G NR, and such a UE may be referred to as a RedCap device. A RedCap device is expected to have limited functionalities and designed to serve limited/specific application(s). The applications are for example, wireless sensors, wearables, and surveillance camera. A RedCap device may be stationary, for longer periods or permanently, to support various applications, e.g. industrial applications, surveillance camera. A UE with stationary property can be exploited to save energy and reduce power consumption, by performing Radio Resource Management (RRM) relaxation, whereby the UE would be able to reduce the measurements of suitable and neighbor cells during certain conditions. One issue is how to classify and detect whether a device is in stationary condition or not. It has been suggested that a stationary property of the UE can be designed by a particular subscription to the network operator, whereby the UE may e.g. be restricted to use one or a few access nodes. However, this may provide an inflexible system design.

### SUMMARY

Consequently, there still exists a need for improvement in the field of determination a mobility level of a UE, to determine a stationary condition. The proposed solutions in view of this objective are set out in the independent claims. Various embodiments are set out in the dependent claims.

According to a first aspect, a method is provided for use in a user equipment, UE, for evaluating a stationary condition of the UE, the method comprising:
measuring a signal property based on one or more signals received from the radio network;
determining a statistical value indicative of signal property variation based on consecutive measurements of the signal property;
determining that the UE is in a stationary condition responsive to the statistical value satisfying a predetermined criterion.

By means of the proposed solution, an improved basis is obtained for the UE to decide on cell reselection strategy and RRM relaxation.

### BRIEF DESCRIPTION OF THE DRAWINGS

Various embodiments will be described with reference to the drawings, in which:

FIG. 1 schematically illustrates a radio network and a wireless device operating in a wireless communication system;

FIG. 2 schematically illustrates elements included in a UE configured in accordance with various embodiments of the proposed solution;

FIG. 3 schematically illustrates elements included in an access node a configured in accordance with various embodiments of the proposed solution;

FIG. 4 illustrates a signaling diagram showing various signals and process steps carried out in different embodiments of the proposed solution;

FIG. 5 schematically illustrates determination of a statistical value of a number of signal measurements, for use in a method according to various embodiments of the proposed solution;

FIG. 6 schematically illustrates a validity check for increasing stability in determination of stationary condition, according to various embodiments of the proposed solution;

FIG. 7 schematically illustrates an embodiment of the proposed solution, making use of positioning reference signals for determining stationary status; and

FIG. 8 schematically illustrates an embodiment of the proposed solution, making use of a beam-specific signal identity for determining stationary status.

### DETAILED DESCRIPTION

In the following description, for purposes of explanation and not limitation, details are set forth herein related to various examples. However, it will be apparent to those skilled in the art that the present disclosure may be practiced in other examples that depart from these specific details. In some instances, detailed descriptions of well-known devices, circuits, and methods are omitted so as not to obscure the description of the present disclosure with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

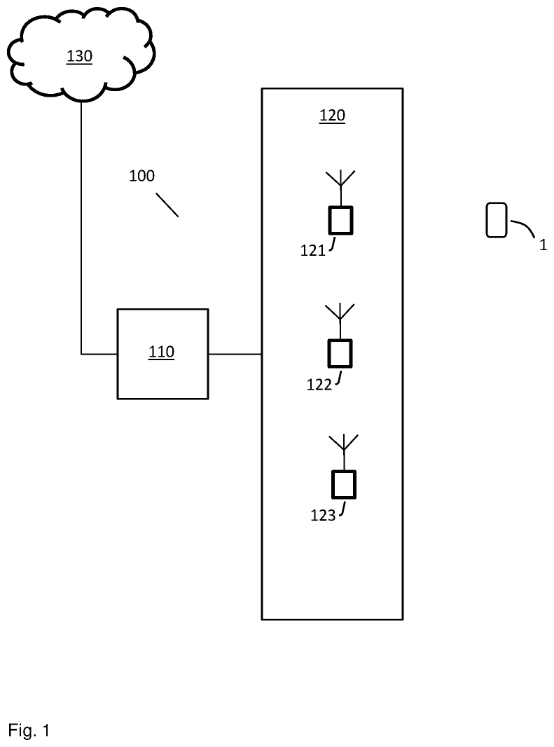

FIG. 1 schematically illustrates a wireless communication scenario, providing an example of a scene in which the solutions provided herein may be incorporated. The wireless communication system includes a wireless network 100, and a UE (or wireless device) 1 configured to wirelessly communicate with the wireless network 100. The wireless network 100 comprises a core network 110, which is connected to other communication networks 130. The wireless network 100 further comprises one or more access networks 120, such as a 5G NR access network, usable for communication with UEs of the system. Such access networks may comprise a terrestrial network 120 comprising a plurality of access nodes or base stations 121, 122, configured to provide a wireless interface for, inter alia, the UE 1. For an NR implementation, the base station may be referred to as a gNB. The base stations 121, 122 may be stationary or mobile. Each base station comprises a point of transmission and reception, referred to as a Transmission and Reception Point (TRP), which coincides with an antenna of the respective base station. Logic for operating the base station may be configured at the TRP or at another physical location.

The UE 1 may be any device operable to wirelessly communicate with the network 100 through the base stations 121, 122, such as a mobile telephone, computer, tablet, a machine to machine (M2M) device, an IoT (Internet of Things) device or other.

Before discussing various process solutions for the proposed method, the UE 1 and a base station 121 will be functionally discussed on a general level.

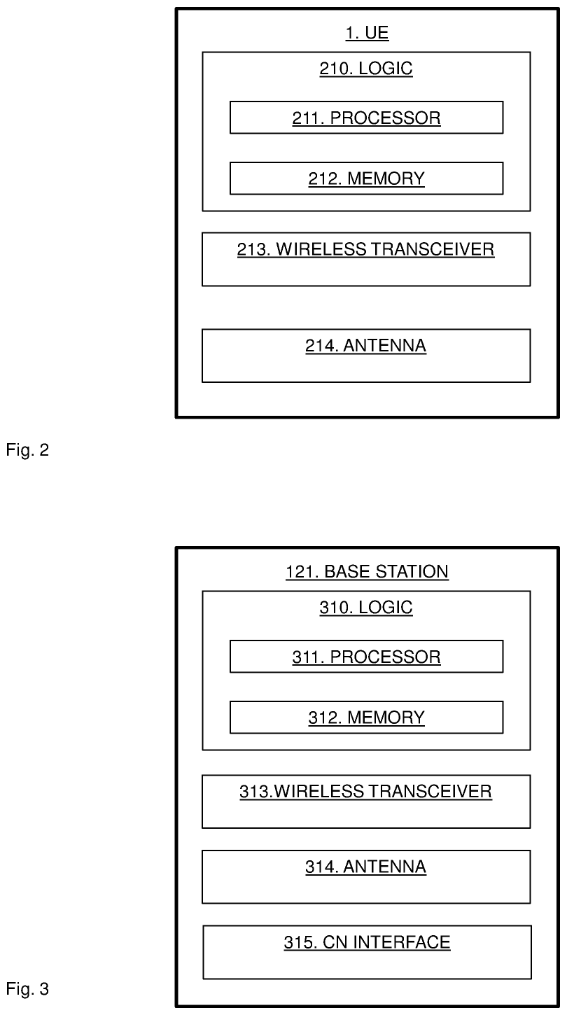

FIG. 2 schematically illustrates an example of the UE 1 for use in a wireless network 100 as presented herein, and for carrying out the method steps as outlined. The UE 1 may be a New Radio (NR) UE in which the UE may be arranged in a connected mode or in an unconnected mode, such as idle or inactive, with regard to a 5G NR cellular access network 120.

The UE 1 comprises a radio transceiver 213 for communicating with other entities of the radio communication network 100, such as the base stations 121, 122 in various frequency bands. The transceiver 213 may thus include a radio receiver and transmitter for communicating through at least an air interface.

The UE 1 further comprises logic 210 configured to communicate data, via the radio transceiver 213, on a radio channel, to at least the wireless communication network 100.

The logic 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage media. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic 210 is configured to control the UE 1 to carry out any of the method steps as provided herein. Software defined by said computer program code may include an application or a program that provides a function and/or a process. The software may include device firmware, an operating system (OS), or a variety of applications that may execute in the logic 210.

The UE 1 may further comprise an antenna system 214, which may include one or more antenna arrays. In various examples the antenna system 214 comprises different antenna elements configured to communicate with the wireless network 100. The antenna system 214 may be operable, by use of the logic 210, to determine an angle of arrival of a received signal.

Obviously, the UE 1 may include other features and elements than those shown in the drawing or described herein, such as a power supply, a casing, a user interface, sensors, etc., but these are left out for the sake of simplicity.

FIG. 3 schematically illustrates an example of a base station 121, such as a gNB.

The base station 121 comprises logic 310 configured to control wireless communication with UEs, and communication with the core network 110. The logic 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic 310 is configured to control the base station 121 to carry out any of the method steps as provided herein. Software defined by said computer program code may include an application or a program that provides a function and/or a process. The software may include device firmware, an operating system (OS), or a variety of applications that may execute in the logic 310.

The base station further comprises a radio transceiver 313 for communicating radio signals with UEs in various frequency bands. The transceiver 313 may thus include a radio receiver and transmitter for communicating through at least an air interface.

The base station 121 may further comprise, or alternatively be connected to, an antenna system 314, which may include one or more antenna arrays. The antenna system 314 is operable by means of the transceiver 313 to communicate with UEs.

In various embodiments, the base station may be arranged to transmit in a plurality of beams, e.g. in a mm wave part of the frequency spectrum, e.g. in Frequency Range (FR) 2. In such embodiments, different spatial configuration may be arranged for different beams transmitted by the antenna system 314.

The base station 121 further comprises a communication interface 315 for connection to the other nodes of the wireless network 100, such as the core network (CN) 110.

5G NR introduces support for various use cases and applications. One example of such applications is industrial applications, where some industrial UEs may be connected and be monitored and optionally controlled remotely. Such a UE does not need to have full functionality of a regular NR UE. On the contrary, such a UE may have reduced capability to reduce complexity and manufacturing cost, as well as minimize the burden on the radio network in terms of signaling. This is currently being considered in NR release 17 to support NR RedCap UEs. Examples of UE complexity reduction features may include:
Reduced maximum UE bandwidth, e.g. 20 MHz during and after initial access for a RedCap UE operating in a lower frequency range (FR), such as of an FR1, and 100 MHz for a RedCap UE operating in a higher frequency range, such as of an FR2.
Reduced minimum number of Rx branches. For frequency bands where a legacy NR UE is required to be equipped with a minimum of 2 Rx antenna ports, the minimum number of Rx branches supported by specification for a RedCap UE may be 1. For frequency bands where some legacy NR UE are required to be equipped with a minimum of 4 Rx antenna ports, the minimum number of Rx branches supported by specification for a RedCap UE may be 1.
Maximum number of DL (downlink) MIMO (Multiple input multiple output) layers. For a RedCap UE with 1 Rx branch, 1 DL MIMO layer may be supported. For a RedCap UE with 2 Rx branches, 2 DL MIMO layers may be supported.
Relaxed maximum modulation order. Support of 256QAM in DL may be optional rather than mandatory for an FR1 RedCap UE.

These and potentially other reduced features may be reflected by UE capabilities, which are identified for the RedCap UE upon registering to the radio network.

It may further be contemplated that a RedCap UE shall be capable of operating with RRM relaxations for e.g. measurement on neighboring cells, based on one or more RRM measurement relaxation criteria. Enabling/disabling of RRM relaxation may be under the network's control.

According to the solutions outlined herein, it is proposed that the UE 1, such as a RedCap UE, is configured to evaluate whether it is in a stationary condition.

In this context, the stationary condition may be a mobility state, in addition to other mobility states, such as normal-mobility state, medium-mobility state, and high-mobility state, as provided for in 3GPP TS38.304 section. 5.2.4.3.

In an alternative example, the stationary condition is not a separate mobility state, but may be an additional or temporary condition regardless of, or as a sub-state of, any mobility state. For example, the evaluation of stationary condition may not necessarily be performed by the UE when the UE is medium/high mobility state.

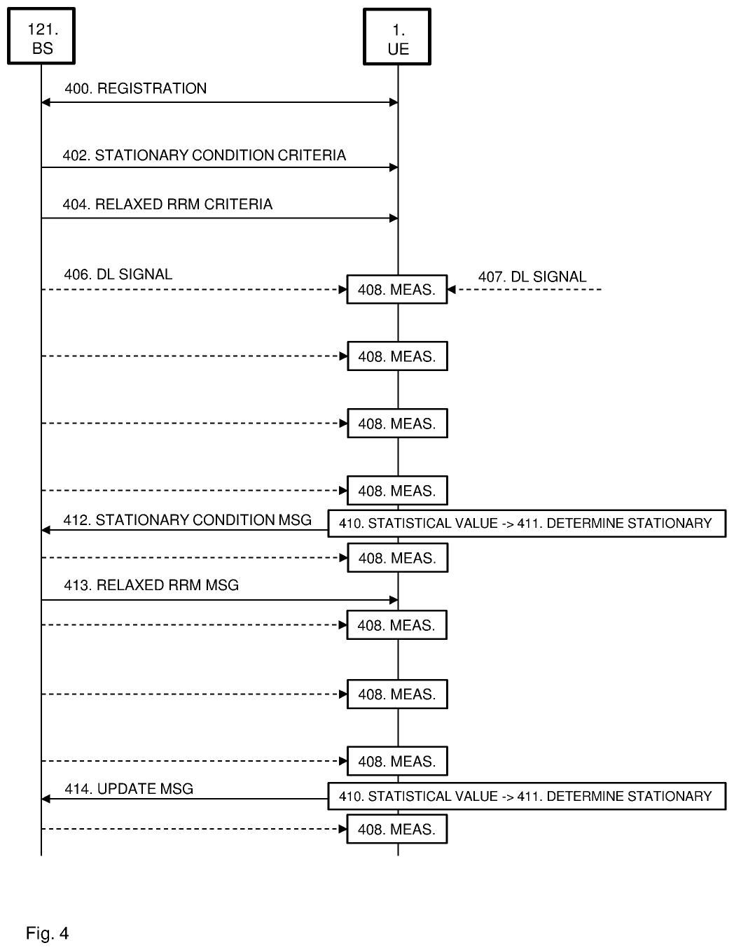

Various aspects of the proposed solution will be described with reference to the drawings, primarily FIG. 4, with more detailed examples set out in the subsequent drawings.

Registration 400 of the UE 1 with the radio network involves identification of UE capabilities, whereby the radio network 100 determines which type of configuration the UE 1 can and/or must be provided with for operating properly in communication with the radio network 100. The UE capabilities may identify the UE 1 as a RedCap device.

In some embodiments, the radio network 100 may transmit a message 402 comprising or identifying one or more criteria for use in the UE to determine stationary condition, or stationary status, i.e. that the UE 1 is not moving with respect to the access network 120. The UE 1 may be configured, by the message 402, to determine stationary condition based on any single criterion of a plurality of received alternative criteria. Alternatively, the UE 1 may be configured, by the message 402, to determine stationary condition based each one, or a predetermined number, of a plurality of received alternative criteria. The message 402 may be transmitted as system information from the radio network 100, such as by the access node 121.

In some embodiments, the radio network 100 may further transmit a message 404 comprising or identifying one or more criteria for the UE to satisfy to operate with relaxed RRM, herein referred to as relaxed cell measurement criteria. In some embodiments, the criteria 404 for RRM relaxation are different from the criteria for determining a stationary condition of the UE 1. In some embodiment, the message 404 may provide whether or not the radio network 100 supports operation of the UE 1 with relax measurement, for example relax measurement for stationary device. The message 404 may be transmitted as system information from the radio network 100, such as by the access node 121.

Based on the received stationary criteria, the UE 1 may be configured to autonomously determine the stationary condition. In one embodiment, the proposed method is carried out only responsive to a message 413 identifying that the UE 1 is allowed to operate with relaxed measurement, e.g. responsive to the UE 1 reporting a stationary condition.

According to a first general aspect, a method is thus carried out in the UE 1 for evaluating a stationary condition of the UE 1, i.e. to determine whether it is stationary. According to an associated aspect, the UE 1 comprises logic 210 configured to operate the UE 1 in accordance with the methods outlined herein. The method comprises measuring 408 a signal property based on one or more signals 406, 407 received from the radio network 100. The signals may be received from a single transmission and reception point, TRP, associated with a single access node 121, or from plural TRPs associated with different access nodes 121, 122 etc. More detail examples will follow.

The method further comprises:
determining 410 a statistical value indicative of signal property variation based on consecutive measurements of the signal property; and
determining 411 that the UE is in a stationary condition responsive to the statistical value satisfying a predetermined criterion. As noted, the predetermined criterion may be one or more of the received stationary criteria of message 402, or it may be a predetermined prescribed criterion determined by specification and thus know to the UE 1.

In this context, the statistical value, or statistic, is a quantity computed from the signal property values based on a certain formula. The detected signal property variation, among the measured signal property values, may be used to determine a maximum expected variation, or deviation from a mean value such as e.g. a standard variation, throughout a period in which those signal properties were measured. In other words, the statistical value is used to assess the signal property variation within the period, based on a limited samples of signal property measurements. As outlined herein, the number of measurements required for the statistical value determination and/or the time window of the period for obtaining those measurements, may be predetermined by specification or may be obtained in the UE in a message 402 from the radio network 100.

By determining a stationary condition or status of the UE 1, further decisions on relaxed RRM may be taken. Specifically, monitoring of the radio network 100 may be restricted to a currently selected cell, as here exemplified being served by the access node 121. Moreover, the periodicity for cell measurements may be extended.

In one embodiment, the predetermined criterion identifies an interval I for repeatedly processing 410 the signal property measurements to assess the statistical value. In the example of FIG. 4, the interval encompasses signal property measurement of 4 consecutively received DL signals. The interval I may be identified as a time window TI, or as a number N1 of signal property measurements. In one example, the time window TI can be operated in the form of a sliding window.

In one embodiment, the predetermined criterion identifies one, or both, of a time window TM for obtaining repeated measurements, and/or identifies a number N2 of measurement occasions. Herein, the term consecutive measurements is used to denote such repeated measurements, which involves a plurality of measurement occasions, wherein a signal property value is obtained at each occasion, for the purpose of determining the statistical value.

The time window TM, or the number N2 of consecutive measurements, may encompass more measurements than the corresponding time window TI or number N1. In other words, the statistical value determined upon one occasion of processing 410 may be based on signal property measurements 408 obtained also before a preceding occasion of processing 410. In various embodiments, each assessment to determine the statistical value is carried out on more than M measurements (or measurement occasions), where M>2, such as M>5, or 2<M<10.

In the example illustrated in FIG. 4, the processing to determine the statistical value is repeated after 4 consecutive measurements. This may be based on the predetermined criterion identifying that N1=4 measurements have been obtained since the last occasion of processing 410, or alternatively based on the time window TI having expired since a last occasion of processing 410.

The method as proposed may be carried out based on different types of DL signals 406, 407 in different embodiments. Some more detailed examples will be provided, but on a more general level, the DL signal may in some embodiments be a reference signal or pilot signal, transmitted by one or more access nodes 121, 122, 123 of the radio network 100. For example, one access node can be the serving gNB in case the UE in connected state or the gNB that the UE is currently camping on in case the UE is in idle/incative state. The reference signal may be a positioning reference signal (PRS). In another embodiment, the DL signal 406 is a synchronization signal block (SSB) transmitted by the access nodes 121. In one embodiment, the DL signal is a channel state information reference signal, CSI-RS.

The signal property measured based on the received DL signals may be of different character in various embodiments. In one example, the signal property is relative time of reception of the DL signal in the UE 1, such as relative time of reception of DL signals 406, 407 from different access nodes 121, 122, 123. In another example, the signal property is received power of the DL signal. In another example, the signal property is angle of arrival of the DL signal, as determined by means of the antenna system 214 of the UE 1. In yet another example, the signal property is a physical resource associated with an identity to carry the said signal, such as a beam identity.

In some embodiments, the statistical value indicative of signal property variation is dependent on a deviation of the signal property between said consecutive measurements. The statistical value may e.g. be a maximum deviation, or a standard deviation, from a certain value level of the signal property. For the example of a standard deviation measure, any given formula may be used in various embodiments, such as a square root of the variance of the N2 signal property measurements, or the signal property measurements within the period TM. The determined statistical value, such as the standard deviation, is subsequently compared by the UE 1, e.g. in a threshold test, to the predetermined criterion, such as a reference standard deviation for allowing determination of stationary condition.

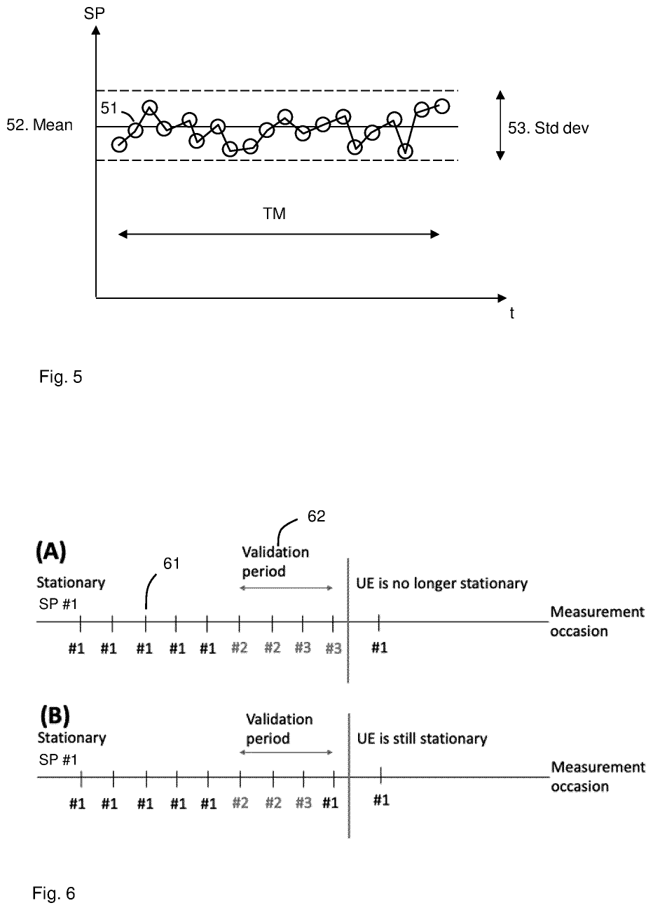

FIG. 5 schematically illustrates an example where a plurality of successive occasions of measuring the signal property are indicated by circles, with the determined signal property (SP) on the vertical axis as a function of time. A line is drawn through the consecutive SP values obtained on each occasion to indicate how the signal property varies. In some embodiments, the predetermined criterion for determining the stationary condition identifies a deviation tolerance of the signal property, within which tolerance the stationary condition may be determined. In some embodiments, the deviation tolerance is a fixed value. In other embodiments, the deviation tolerance is a value dependent on a mean value 52 of the determined signal property, determined over a measurement period defined by the time window TM or by the N2 number of measurements. In some embodiments, the predetermined criterion identifies that a standard deviation 53, or a maximum deviation, in the measurement period must not exceed a certain threshold value, which may be a fixed SP value, or the mean SP value determined by the UE 1.

In some embodiments, where the UE 1 determines that is in a stationary condition, based responsive to the statistical value satisfying the predetermined criterion, the method may comprise transmitting 412 a message to the radio network 100, indicating the determination of the stationary condition. This way, the radio network 100 is made aware of the fact that the UE 1 is deemed to be stationary, and may thus configure future signaling with the UE 1 more efficiently. In one embodiment, the radio network 100 is configured to initiate paging of the UE 1, based on a data being scheduled to be sent to the UE 1, through the access node 121 in which the message 412 declaring the stationary condition was received. This way, resource configuration for paging may be optimized.

As indicated above and as illustrated in FIG. 4, the method may comprise repeatedly determining and assessing 410 the statistical value with respect to the predetermined criterion with a predetermined interval. Responsive to the UE 1 determining that it is no longer in the stationary condition, the UE 1 may be configured to transmit 414 an update message to the radio network 100. This is particularly the case when the message content(s) 414 is not the same as the message 412 (e.g., the UE is no longer stationary). This way, the radio network 100 is conveniently alerted upon the UE 1 changing its determined status with regard to the stationary condition.

Once the UE 1 is in stationary condition, various other conditions may change that can affect the status of the UE 1 as stationary, such as vehicles or other objects obscuring a beam. In order to avoid a ping-pong effect, validation of the stationary condition is carried out in some embodiments.

FIG. 6 schematically illustrates two separate examples of processing 410 to determine stationary condition of the UE 1. Each assessment occasion 61 of processing 410 to determine that the UE 1 is in a stationary condition time is indicated by one instance in time. For each example, the UE 1 has determined that it is stationary, based on the signal property SP #1 satisfying the predetermined criterion. At each assessment occasion 61, this is based on a plurality of consecutive signal measurements as described herein. In this embodiment, a validation period 62 is applied over a multitude of assessment occasions.

In scenario A, the validation period covers a last 4 assessment occasions 61, and within that validation period none of the assessments result in the statistical value based on a signal property meet the predetermined criterion for determining that the UE 1 is stationary. The UE 1 is thereby triggered to transmit an update message 414 indicating that the UE 1 is no longer stationary.

In scenario B, one assessment occasion results in the statistical value meeting the predetermined criterion for determining that the UE 1 is stationary. The UE 1 is then not triggered to transmit any update message 414, and will remain in the stationary condition.

In some embodiments, the update message 414 is transmitted in a message part of a random access procedure, while the UE 1 is in an idle or inactive state with respect to the radio network 100. This may be carried out using so-called small data transmission (SDT), which involves transmission of small data packets from inactive or idle state, e.g. using MSGA in a two-step RACH procedure or MSG3 in a four-step RACH procedure. The indication of stationary condition may be provided by one bit in such an SDT message.

The indication of stationary condition may have an associated validity time, and/or being valid until an update 414 of the status indicator is received in the radio network 100. The update 414 can be periodic, for a maximum duration, or aperiodic, only when the status has changed or triggered by gNB.

In various embodiments, the UE 1 may receive a message 413 from the radio network 100 associated with a relaxed cell measurement condition, based on determining the stationary condition. In some embodiments, the message 404 associated with a relaxed cell measurement provides criteria for relaxed measurement condition, whereby the UE 1 may autonomously determine if criteria for relaxed measurement are fulfilled once the stationary condition is determined. In another embodiment, the UE 1 may receive the message 413 associated with a relaxed cell measurement condition as a separate message, upon reporting 412, 414 a stationary condition. The activation, or allowance to activate, relaxed measurement, is in these embodiments separate and additional to the determination of stationary condition. Based on said relaxed cell measurement condition, the UE 1 is configured to monitor the radio network 100 using relaxed cell measurement.

According to this aspect, the proposed solution further involves, in some embodiments, a method carried out in the access node 121 of the radio network 100 for configuring the UE 1, wherein the method comprises:
receiving, from the UE 1, a message indicating a stationary condition of the UE;
transmitting, to the UE, a message associated with a relaxed cell measurement condition, based on the stationary condition. The message associated with a relaxed cell measurement condition may comprise one or more criteria for the UE to determine allowance to activate relaxed measurement. Alternatively, the message associated with a relaxed cell measurement condition indicates activation or inactivation of relaxed measurement.

Some further examples of the proposed solution will now be described.

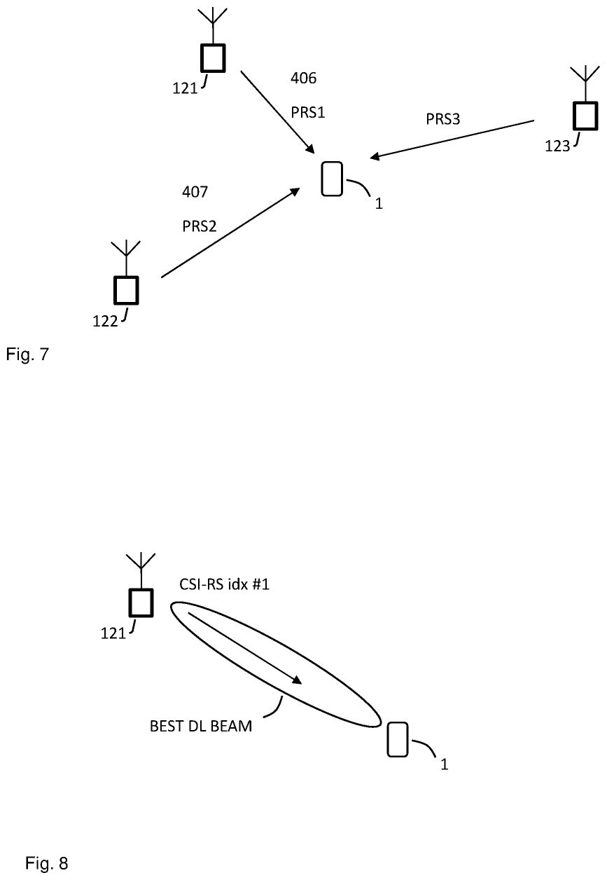

FIG. 7 illustrates an embodiment in which the UE 1 receives legacy PRSs from multiple access nodes, here exemplified by access nodes 121, 122, 123. The UE 1 does not need to make a full positioning measurement based on the PRSs. These signals are merely used to obtain a signal property which is monitored for stability in the consecutive measurements, such as a relative time of reception of two or more of PRS1. PRS2, PRS3. Each measurement thus entails receiving at least two DL signals 406 (PRS1) and 407 (PRS2). The PRSs may for instance be configured on-demand for a specific or groups of UEs to be uses in Idle/Inactive mode of the UE 1. Determining the statistical value may involve determining a fluctuation of the measured relative time difference throughout the consecutive measurements. In an alternative embodiment, particularly minimizing power consumption, the UE1 is only required to perform positioning measurement based on one downlink PRS. For example, UE1 performs time of arrival (TOA) measurement based on DL signals 406 (PRS1). In further alternative, or additional, variants of this embodiment of using PRS, the measured signal property is instead received power, or angle of arrival (AOA), of one or more PRSs, and the fluctuation of that signal property is determined by the statistical value.

A stationary condition may be determined to be obtained once the statistical value satisfies the predetermined criterion, such as the PRS relative timing (possibly also/alternatively TOA, AOA, power) measurement in multiple consecutive occasions being relatively constant or within certain std. deviation, as exemplified.

Once the UE 1 determines a stationary condition, the UE 1 may declare 412, 414 the stationary condition to the radio network 100, and possibly also reports the obtained signal property measurement results (e.g. TDOA or RSTD).

The UE 1 may perform signal measurements either periodically or aperiodically/triggered based on on-demand PRS. Subsequent signal measurements can be used to validate whether the UE is still in stationary or not, and to transmit an update message 414 when the condition changes.

PRS measurement can be measured for selected access nodes or TRPs, based on UE 1 preference or as instructed by the radio network 100.

FIG. 8 schematically illustrates another example of how the proposed solution may be realised. Here, the UE 1 is configured to determine stationary condition based on NR signals. UE 1 signal measurements can be reference signal received power (RSRP). The statistical value may be determined as a fluctuation of deviation within a certain period of time, such as a standard deviation for a given mean value within that period of time, as outlined with reference to FIG. 5.

The reference signal can be based on SSB and/or CSI-RS and/or PRS. In some embodiments, the UE 1 is configured to use SSB when the UE 1 is in idle/inactive mode, to use CSI-RS used when the UE 1 is in connected mode. PRS can be used in connected and/or idle/inactive state.

In accordance with FIG. 4, the radio network 100, such as a serving base access node 121, provides 402 criteria/conditions/requirement for the UE 1 to be able to declare as a stationary condition. This can be in a form of condition parameters, or criteria parameters with certain thresholds. This information may be broadcast by the access node 121 using System Information Blocks (SIB). The broadcast information may include various different types of information, such as any combination of:
Reference signal resource(s): SSB and/or CSI-RS and/or PRS. When the access node 121 transmits reference signal in a specific resource, that resource is typically associated with certain beam direction. Furthermore, a transmission of CSI-RS may also be associated with SSB transmission in a form of Quasi co-located (QCL) information. The beam for CSI-RS is known to have narrower beam than SSB's beam.
The number of occasions where the UE 1 must obtain the best measurement from the same reference signal resources. For example: the UE 1 may determine that is in stationary condition if the UE 1 always obtain the best RSRP from the same resources consecutively, for a given number of occasions.
Standard deviation of the received power (RSRP). For example: The UE 1 may determine that it is in stationary condition if the standard deviation is within certain thresholds.
Minimum time duration (TM), or number of measurements (N2), where the measurement to determine stationary condition shall be performed.
The proposed method of determining a statistical value for plural consecutive measurements allows for a solution which, even when the UE 1 is doing measurements on several beams, allows for a stable solution for determining a stationary condition in the event the surrounding environment changes and affect radio conditions while the UE 1 does not move.

In the various embodiments outlined herein, the UE 1 may be configured to perform signal measurement 408, processing 410, and reporting 412, 414 when the UE 1 is in idle/inactive mode. This may e.g. be accomplished by Idle/Inactive mode UE based positioning (or only using time measurements involved in UE based positioning) in order to establish the stationary condition. As noted, if both the UE 1 and the radio network 100 are provided with a common understanding of whether the UE 1 is truly stationary or not, by means of the reporting 412, 414, and by that know whether cell/beam reselection depends on mobility or changing radio conditions, this leads to both that network paging and beam strategy can be enhanced, and that UE 1 cell reselection strategy and RRM relaxation can be effectively achieved, compared to legacy solutions.

It shall be noted that unless being clearly contradictory, all aspects of the different embodiments outlined herein may be combined in any way, including any of the features outlined in the appended claims.

1. A method carried out in a user equipment (UE), for evaluating a stationary condition of the UE, the method comprising:
measuring a signal property based on one or more signals received from the radio network;
determining a statistical value indicative of signal property variation based on consecutive measurements of the signal property;
determining that the UE is in a stationary condition responsive to the statistical value satisfying a predetermined criterion.

2. The method of claim 1, comprising:
receiving, from the network, one or more criteria comprising said predetermined criterion, for determining the stationary condition.

3-10. (canceled)

11. The method of claim 1, further comprising:
repeatedly assessing the statistical value with respect to the predetermined criterion with a predetermined interval; and
transmitting an update message to the network based on determining that the UE is no longer in the stationary condition, wherein the update message is transmitted in a message part of a random access procedure while the UE is in an idle state or Inactive state with respect to the radio network.

12-21. (canceled)

22. The method of claim 1, comprising:
receiving, from the radio network, a message associated with a relaxed cell measurement condition, based determining the stationary condition; and
monitoring the radio network using relaxed cell measurement, based on the relaxed cell measurement condition.

23. A method carried out in an access node of a radio network for configuring a user equipment (UE), the method comprising:
receiving, from the UE, a message indicating a stationary condition of the UE;
transmitting, to the UE, a message associated with a relaxed cell measurement condition, based on the stationary condition.

24. The method of claim 23, comprising:
transmitting one or more criteria for use by the UE to determine allowance to activate relaxed measurement.

25. The method of claim 23, wherein said message associated with a relaxed cell measurement condition indicates activation or inactivation of relaxed measurement.

26. The method of claim 1, wherein said signal is a positioning reference signal (PRS).

27. The method of claim 26, wherein said PRS is an on-demand PRS configured for use by the UE in Idle/Inactive mode.

28. The method of claim 26, wherein said signal property is associated with relative time of PRS reception from a plurality of access nodes of the radio network.

29. The method of claim 1, wherein said signal property is a determined angle or time of arrival of the signal in the UE.

30. The method of claim 26, wherein said signal property is received power of the signal, or a physical resource associated with an identity to carry the said signal.

31. The method of claim 23, wherein the message received from the UE is based on a positioning reference signal (PRS) transmitted from access nodes of the radio network.

32. The method of claim 31, wherein said PRS is an on-demand PRS configured for use by the UE in Idle/Inactive mode.

33. The method of claim 23, comprising:
transmitting a message identifying one or more criteria for use in the UE to determine stationary condition.
